(19) United States
(12) Patent Application Publication
(10) Pub. No.: US 2018/0012293 A1
(43) Pub. Date: Jan. 11, 2018

(54) MULTI-THREAD AUCTIONS

(71) Applicant: eBay Inc., San Jose, CA (US)

(72) Inventors: Himanshu Jain, Sikar (IN); Rama Krishna Vadakattu, Bangalore (IN); Swarnim Naraya, Jharkhand (IN); Harshal Suresh Godhia, Mumbai (IN)

(21) Appl. No.: 15/205,835

(22) Filed: Jul. 8, 2016

(51) Int. Cl. G06Q 30/08; H04L 12/58; G06N 99/00

(52) U.S. Cl. CPC G06Q 30/08; G06N 99/005; H04L 51/04

(57) ABSTRACT

Users using different messaging webservices or social network platforms can participate in an auction managed by a multi-thread auction system. Users on a first platform may bid on the auction through a message thread configured for the first platform, and users on a second platform may bid on the auction through a message thread configured for the second platform. The communications may be ordered for submission, based on the order in which they were generated, by a machine learning engine that generates its own training data. As communications are received, the machine learning engine adjusts their submission times using the learned model.

### TECHNICAL FIELD

Embodiments of the present disclosure relate generally to integrating network communications between multiple platforms and, more particularly, but not by way of limitation, to managing an auction using communications from multiple platforms.

### BACKGROUND

Generally, a webservice hosted from a server can interact with client devices througth interfaces that are integrated with and configured for the webservice. For example, a user may interact with an auction webservice through an auction website with specially constructed user interfaces (e.g., buttons, links, display elements) that allow the user perform webservice actions using HTTP requests/responses. However, not all websites are configured to work with one another, and a user must generally interact with a given webservice through the portal specifically created to access the webservice (e.g., a website, a client application). In some webservices, the timing of user actions can be of paramount importance. For example, in an auction webservice, if a user submits a bid after the auction timer expires, the bid is not valid. Furthermore., different types of webservices use different network architectures, with different timing characteristics. The differences in timing of different architectures frustrates a time-sensitive webservice's ability to interact with users on different platforms.

As is evident, there is a demand for multiple platform webservice integration.

### BRIEF DESCRIPTION OF THE DRAWINGS

Various ones of the appended drawings merely illustrate example embodiments of the present disclosure and should not be considered as limiting its scope.

FIG. 1 is a block diagram illustrating a network architecture, according to some example embodiments.

FIG. 2 is a block diagram showing example components provided within the system of FIG. 1, according to some example embodiments.

FIG. 3 is a flow diagram illustrating an example method for performing multi-thread auctions, according to some example embodiments.

FIG. 4 is a flow diagram illustrating an example method for performing communication processing, according to some example embodiments.

FIG. 5A is a flow diagram illustrating an example method for determining times that communications were submitted, according to an example embodiment.

FIG. 5B illustrates an example network schematic for a bid sequencer engine, according to some example embodiments.

FIGS. 6A and 6B are flow diagrams illustrating methods for terminating an auction, according to some example embodiments.

FIGS. 7A-7E show example client devices and user interfaces for implementing multi-thread auctions, according to some embodiments.

FIG. 8 is a flow diagram illustrating an example method for finding potential bidders using data from a social network, according to some embodiments,

FIG. 9 is a diagrammatic representation of a machine in the form of a computer system within which a set of instructions may be executed for causing the machine to perform any one or more of the methodologies discussed herein, according to an example embodiment.

### DETAILED DESCRIPTION

The description that follows includes systems, methods, techniques, instruction sequences, and computing machine program products that embody illustrative embodiments of the disclosure. In the following description, for the purposes of explanation, numerous specific details are set forth in order to provide an understanding of various embodiments of the inventive subject matter. It will be evident, however, to those skilled in the art, that embodiments of the inventive subject matter may be practiced without these specific details. In general, well-known instruction instances, protocols, structures, and techniques are not necessarily shown in detail.

In various example embodiments, users using different messaging webservices or social network platforms can participate in an auction managed by a. multi-thread auction system. The multi-thread auction system may post different message threads to different platforms, such as Twitter and Facebook. Users on Twitter may bid on the auction through the Twitter message thread and users on Facebook may bid on the same auction through the Facebook message thread. The multi-thread auction system uses a multi-platform sequencer engine to determine the times messages from the different platforms were submitted. The multi-platform sequencer engine may use a machine learning scheme to determine delay times for communications arriving from the different platforms. The time of receipt of communications may be offset by the multi-platform sequencer to ensure that the communications from different platforms are handled in the order they were submitted, not necessarily received.

Users bidding through the different platforms can use tags to indicate their intended action. For example, a user can include a bid tag such as “#mybid”, along with a bid value. The auction may be terminated through the seller choosing a bidder in an auction ending message, such as “Bidder 1, you won! #sellit”, where the “#sellit” tag indicates to the multi-thread auction system that the seller is selecting a winner, thereby terminating the auction. In some embodiments, when a seller posts about an item for sale, the multi-thread auction system may find potential buyers of the item by accessing social graph data of the seller to find friends of the seller who may be interested in buying the item (e.g., buying the item as part of a multi-thread auction). In this way, auctions can be performed over a network on one or more platforms.

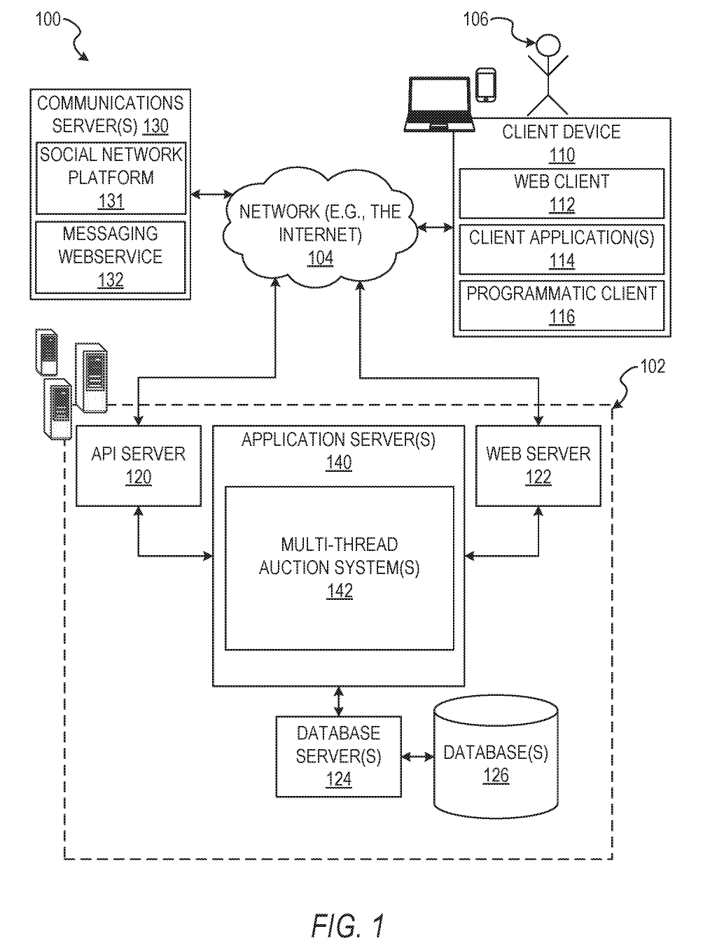

With reference to FIG. 1, an example embodiment of a high-level client-server-based network architecture 100 is shown. A networked system 102, in the example forms of a network-based marketplace or payment system, provides server-side functionality via a network 104 (e.g., the Internet or a wide area network (WAN)) to one or more client devices 110. In some implementations, a user (e.g., user 106) interacts with the networked system 102 using the client device 110. FIG. 1 illustrates, for example, a web client 112 (e.g., a browser, such as the INTERNET EXPLORER® browser developed by MICROSOFT® Corporation of Redmond, Wash. State), client applications 114, and a programmatic client 116 executing on the client device 110. The client device 110 includes the web client 112, the client application(s) 114, and the programmatic client 116 alone, together, or in any suitable combination. Although FIG. 1 shows one client device 110, in other implementations, the network architecture 100 comprises multiple client devices.

In various implementations, the client device 110 comprises a computing device that includes at least a display and communication capabilities that provide access to the networked system 102 via the network 104. The client device 110 comprises, but is not limited to, a remote device, work station, computer, general purpose computer, Internet appliance, hand-held device, wireless device, portable device, wearable computer, cellular or mobile phone, Personal Digital Assistant (PDA), smart phone, tablet, ultrabook, netbook, laptop, desktop, multi-processor system, microprocessor-based or programmable consumer electronic system, game console, set-top box, network Personal Computer (PC), mini-computer, and so forth. In an example embodiment, the client device 110 comprises one or more of a touch screen, accelerometer, gyroscope, biometric sensor, camera, microphone, Global Positioning System (GPS) device, and the like.

The client device 110 communicates with the network 104 via a wired or wireless connection. For example, one or more portions of the network 104 comprise an ad hoc network, an intranet, an extranet, a Virtual Private Network (VPN), a Local Area Network (LAN), a wireless LAN (WLAN), a WAN, a wireless WAN (WWAN), a Metropolitan Area Network (MAN), a portion of the Internet, a portion of the Public Switched Telephone Network (PSTN), a cellular telephone network, a wireless network, a Wireless Fidelity (WIFI®) network, a Worldwide Interoperability for Microwave Access (WiMax) network, another type of network, or any suitable combination thereof.

In some example embodiments, the client device 110 includes the one or more client applications 114 (also referred to as “apps”) such as, but not limited to, web browsers, book reader apps (operable to read e-books), media apps (operable to present various media forms including audio and video), fitness apps, biometric monitoring apps, messaging apps, electronic mail (email) apps, and e-commerce site apps (also referred to as “marketplace apps”). In some implementations, the client application(s) 114 include various components operable to present information to the user and communicate with the networked system 102. In some embodiments, if the e-commerce site application is included in the client device 110, then this application is configured to locally provide the user interface and at least some of the functionalities of an e-commerce site, with the application configured to communicate with the networked system 102, on an as-needed basis, for data or processing capabilities not locally available (e.g., to access a database of items available for sale, to authenticate a user, to verify a method of payment). Conversely, if the e-commerce site application is not included in the client device 110, the client device 110 can use its web client 112 to access the e-commerce site (or a variant thereof) hosted on the networked system 102.

The web client 112 accesses the various systems of the networked system 102 via the web interface supported by a web server 122. Similarly, the programmatic client 116 and client application(s) 114 access the various services and functions provided by the networked system 102 via the programmatic interface provided by an Application Programming interface (API) server 120. The programmatic client 116 can, for example, be a seller application (e.g., the Turbo Lister application developed by EBAY® Inc., of San Jose, Calif.) to enable sellers to author and manage listings on the networked system 102 in an offline manner, and to perform batch-mode communications between the programmatic client 116 and the networked system 102.

Users (e.g., the user 106) comprise a person, a machine, or another means of interacting with the client device 110. In some example embodiments, the user 106 is not part of the network architecture 100, but interacts with the network architecture 100 via the client device 110 or another means. For instance, the user 106 provides input (e.g., touch screen input or alphanumeric input) to the client device 110 and the input is communicated to the networked system 102 via the network 104. In this instance, the networked system 102, in response to receiving the input from the user 106, communicates information to the client device 110 via the network 104 to be presented to the user 106. In this way, the user 106 can interact with the networked system 102 using the client device 110.

The API server 120 and the web server 122 are coupled to, and provide programmatic and web interfaces respectively to, one or more application server(s) 140. The application server(s) 140 can host a multi-thread auction system(s) 142, which comprises one or more modules or applications and which can be embodied as hardware, software, firmware, or any combination thereof. The application server(s) 140 are, in turn, shown to be coupled to one or more database server(s) 124 that facilitate access to one or more information storage repositories or database(s) 126. In an example embodiment, the database(s) 126 are storage devices that store information (e.g., publications or listings) to used in managing auction instances by the multi-thread auction system(s). The database(s) 126 also stores digital goods information in accordance with some example embodiments.

The multi-thread auction system(s) 142 is configured to manage an auction on the application server(s) 140, with bids submitted from one or more communication server(s) 130, which may host, for example, a messaging webservice 132 (e.g., WhatsApp, Facebook Messenger) or a social network platform 131 (e.g., Facebook, Instagram, Snapchat, Twitter, LinkedIn, Google+). The user 106 may use his/her client device 110 to access the messaging webservice 132 and the social network platform 131 to transmit bid requests for an auction being managed through the multi-thread auction system(s) 142, as described in further detail below. Further, while the client-server-based network architecture 100 shown in FIG. 1 employs a client-server architecture, the present inventive subject matter is, of course, not limited to such an architecture, and can equally well find application in a distributed, or peer-to-peer, architecture system, for example. The various systems of the applications server(s) 140 (e.g., the multi-thread auction system(s) 142) can also be implemented as standalone software programs, which do not necessarily have networking capabilities.

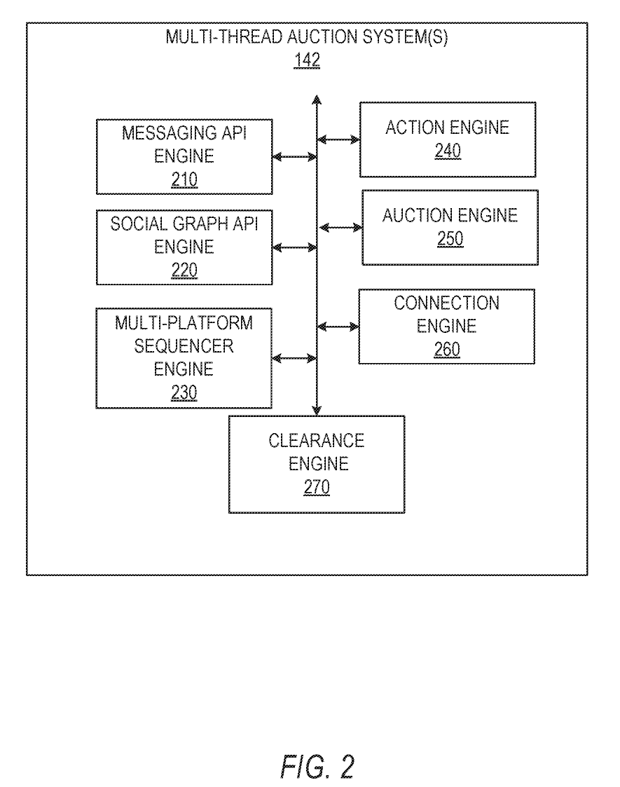

FIG. 2 is a block diagram showing components provided within the multi-thread auction system(s) 142, according to some example embodiments. The components themselves are communicatively coupled (e.g., via appropriate interfaces) to each other and to various data sources, so as to allow information to be passed between the components or so as to allow the components to share and access common data. Furthermore, the components access the one or more database(s) 126 via the database server(s) 124. To this end, the multi-thread auction system 142 comprises a messaging API engine 210, a social graph API engine 220, a multi-platform sequencer engine 230, an action engine 240, an auction engine 250, a connection engine 260, and a clearance engine 270.

The messaging API engine 210 is configured to communicate with different APIs of different messaging webservices (e.g., Facebook Messenger, Twitter) and social network platforms (e.g., Facebook, LinkedIn, Google+) available through the Internet. To interface with each messaging webservice or social network platform, the messaging API engine 210 is configured with multiple API modules, each configured to interface with an API specified by the messaging webservice or the social network platform. In some example embodiments, when the messaging API engine 210 receives a new communication, it first determines which platform sent the communication. Once the platform is identified, the messaging API engine 210 loads the appropriate API module from the library and parses the message.

The social graph API engine 220 is configured to interface with different social network platforms to access their respective social graph datasets. The social graph datasets can be utilized by the action engine 240 to generate notifications to friends of bidding users. The social graph datasets may also be transferred to the connection engine 260 to find potential users interesting in buying an item, as described in further detail below.

The multi-platform sequencer engine 230 is configured to receive communications from different platforms and determine the order in which the communications were sent by users of the different platforms. The order identification is performed to ensure that users' bids that were submitted first but arrive late due to network slowness are treated fairly and submitted as bids in the correct order, as explained in further detail below.

The action engine 240 is configured to parse the incoming communications and determine the appropriate action to perform. In some embodiments, the action engine 240 extracts tags or keywords from the incoming communication to identify a communication type and corresponding action. For example, the action engine 240 may parse “#mybid $240” to determine that the communication is a bid request of 240 dollars for a given item.

The auction engine 250 may create an auction instance or webservice for an item being auctioned. For example, an auction request may be received, and in response to the request an auction instance to sell the item may be created. In some embodiments, the auction engine 250 first generates an auction and auction webpage, then updates the auction with bid data received through the different messaging webservices, as described in further detail below.

The connection engine 260 is configured to access, via the social graph API engine 220, social graph data of a given social network platform and identify potential users that may be interested in buying an item posted by a user. For example, a first member of a social network may have submitted a post in a social network about an item the first member is interested in selling. In response to the post about the item, the connection engine 260 accesses social graph data to determine if the first member has any connections (e.g., friends) who may be interested in purchasing the item for sale. In some embodiments, the connection engine 260 may further be configured to determine whether the first member of the social network has any second-, third-, or n-degree connections to users who may be interested in buying the item for sale, as explained in further detail below.

In some embodiments, the clearance engine 270 is configured to generate a checkout instance and corresponding database processes to check out (e.g., pay for) the item being auctioned. A link to the checkout instance may be created by the clearance engine 270 and sent through the messaging Am engine 210 to the winning bidder, who can then click on the link and be taken to the checkout instance to complete the transaction for the item.

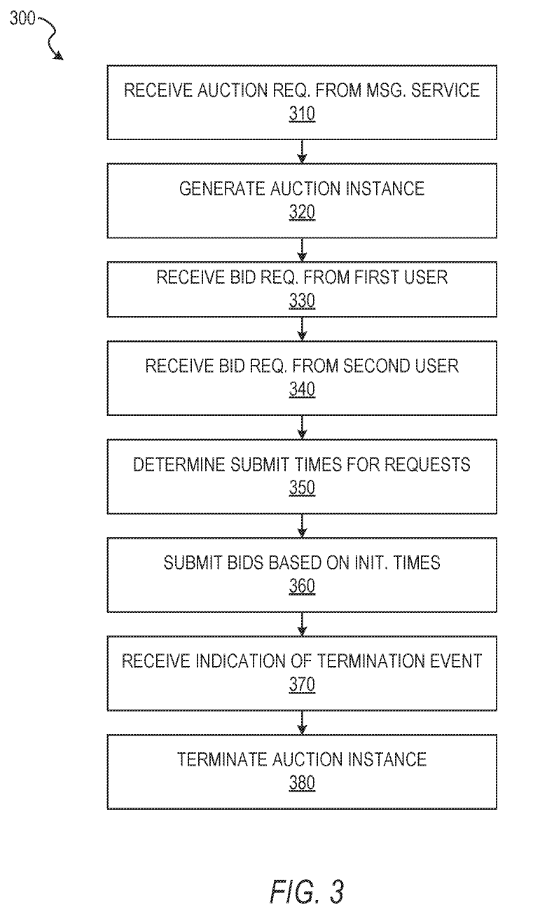

FIG. 3 is a flow diagram 300 of a method for performing a multi-thread auction, according to some example embodiments. At operation 310, the messaging API engine 210 receives an auction request to initiate an auction for an item. The action engine 240 may parse the auction request and identify metadata tags that indicate that an auction for an item is being requested.

At operation 320, the auction engine 250 generates an auction instance for the item. In some embodiments, the auction engine 250 further generates an auction message to be posted by the user who sent in the auction request. The auction message may comprise one or more of the following: information about the item being auctioned, a link to a webpage on the auction server to view the auction, and instructions about how to complete bids through the messaging webservice. The auction message serves as the message thread for the auction, and the entire auction process may be conducted from the messaging service through the message thread, according to some example embodiments. In some example embodiments, different threads on different messaging platforms or social media platforms are used to complete the auction.

An operation 330, the messaging API engine 210 receives a hid request from a first user through the API of the messaging service. The bid request comprises a bid metadata tag that indicates to the action engine 240 that the communication is a bid request. The bid request may further comprise the bid value (e.g., bid price) for the item being bid upon. The first user may be identified by metadata of the bid request (e.g., header data), such as a user ID. In some embodiments, the item being bid for may be identified from an item tag in the message that identifies the auction instance. Further, in some example embodiments, the first user need not specify the item being bid for in the message, but may instead select “reply” on a message thread. In those example embodiments, the action engine 240 determines through bid request metadata that the bid request was generated as a reply to a message thread associated with the auction instance.

At operation 340, the messaging API engine 210 receives a bid request from a second user also bidding on the item. The bid request of the second user is similar to the bid request of the first user, but may specify a different bid value. The second user may be a user submitting a bid on a messaging platform different from the messaging platform the first user used to submit his or her bid.

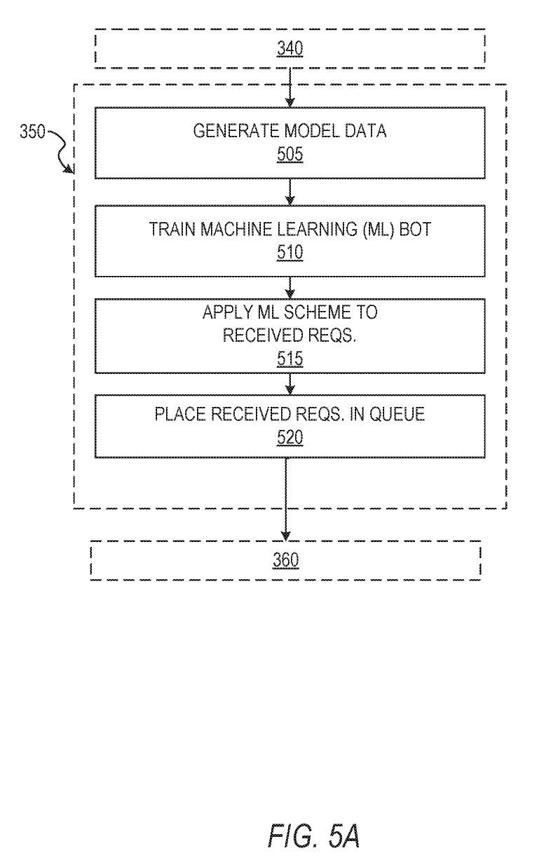

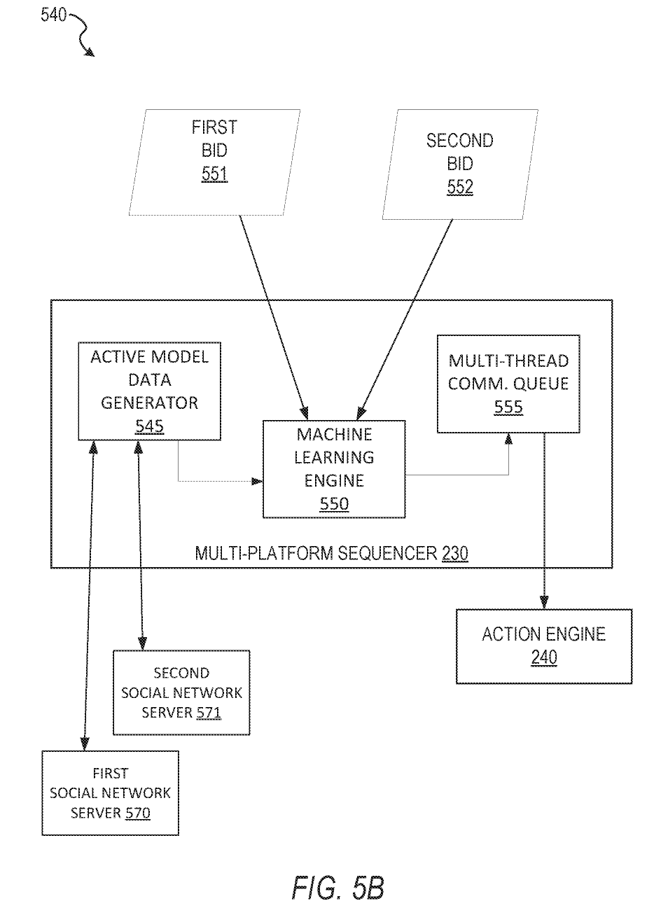

At operation 350, the multi-platform sequencer engine 230 determines which bid—the first or second bid—was submitted first. For example, the first bid may have been submitted at 1:00 PM PST, and the second bid may have been submitted at 1:01 PM PST (one minute later); however, due to network infrastructure issues of the messaging platform of the first bid, the second bid is received by the multi-thread auction system(s) 142 before the first hid. This issue is compounded by multiple time zones, multiple hubs being traversed, and different network protocols of different messaging services. The multi-platform sequencer engine 230 solves the timing issue by analyzing the bid submitting networks and intelligently ordering the bids based on the analysis. At operation 360, the first bid and second bid are submitted in the order they are received as determined at operation 350. Further details on communication order determination are discussed with reference to FIGS. 5A-5B, below.

At operation 370, the messaging API engine 210 receives indication of a termination event. The termination event may, according to some example embodiments, be an expiry of a timer, where the auctions are timed (e.g., a 24-hour auction: at the end of 24 hours, the bidder with the highest bid wins). In other embodiments, the termination event may be a termination message by the seller, or the creator of the auction, selecting a user as a winner. At operation 380, the auction engine 250 terminates the auction instance.

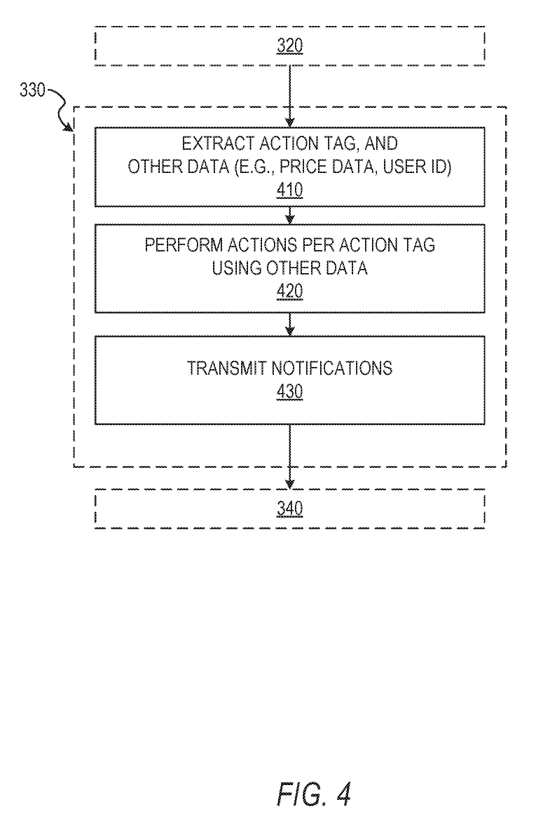

FIG. 4 illustrates a sub-routine for operation 330 of FIG. 3, which is receiving a bid request from a first user. In some example embodiments, the action engine 240 is configured to receive a communication, such as a bid request, and identify metadata tags or action tags from the communication to determine the type of communication (e.g., bid type, termination type). At operation 410, the action engine 240 receives the message, and extracts an action tag, such as a metadata tag, and other data, such as price data or a user ID. At operation 420, according to what action tag is extracted, the action engine 240 transmits instructions to other modules, such as the auction engine 250, to complete tasks according to the action tag. For example, where the message contains a bid metadata tag and a price value, the action engine 240 may instruct the auction engine 250 to submit the bid according to the price in the message. At operation 430, once the action is performed, the messaging API engine 210 may transmit notifications, updating multiple message threads on multiple platforms to reflect the current state of the auction instance. For example, where a bid request is made for an auction, the messaging API engine 210 may update a message thread to indicate that the bid price has been increased by a bid.

FIG. 5A illustrates a sub-routine that corresponds to operation 350 of FIG. 3, which is determining the initiation times for the requests. At operation 505, the multi-platform sequencer engine 230 generates model data that a machine learning engine in the multi-platform sequencer engine 230 uses for training. In some example embodiments, the model data is generated by sending ping packets to different messaging webservices and social network platforms to determine round trip time for the packets, where round trip time is the time it takes for packets to go to the destination platform and return to the multi-thread auction system(s) 142. Round trip time for different platforms can change based on how far the servers are located geographically from the multi-thread auction system(s) 142, the number of hubs crossed in a round trip, the quality of the network infrastructure (e.g., quality of computational/network components, and network layout) of the different platforms, and other factors. Once the round trip time is known for a given platform, the network delay for the platform is identified as round trip time divided by two (e.g., RTT/2=delay), where an assumption is being made that the trip to the platform takes the same amount of time as the trip to the multi-thread auction system(s) 142 from the platform, according to some example embodiments. In some embodiments, the ping packets return information including the application or platform sending the ping packet, the application or platform returning the ping packet, the hour of day, the minute of the hour, the total return trip time, a geographic location/country of the application or platform server returning the ping packet, third party applications utilized, and/or the number of network hubs traversed in each direction (going to the destination platform and returning from the destination platform). In some embodiments, the delay time is modified if it is determined that the trip to the platform is longer than the trip from the platform, for example where the number of hubs traversed by the ping packets is far greater than the number of hubs traversed returning from the platform. In operation 505, the multi-platform sequencer engine 230 generates the model data for each messaging platform to be utilized in a multi-thread auction.

At operation 510, a machine learning engine is trained on the model data generated by operation 505. In some embodiments, the machine learning engine is configured as a gradient boosting algorithm or random forest, which aggregates the results of multiple decision trees to generate a strong signal for delay time from a collection of weak signals for delay time for a given platform.

At operation 515, the multi-platform sequencer engine 230 applies the model-trained machine learning engine to the received bids to determine the delay times for each of the received bids based on which platform each bid was sent from. At operation 520, the multi-platform sequencer engine 230 places the received bids in a multi-thread bid queue based on the times the bids were received as adjusted by the delay times. Once the bids are in the bid queue, other modules of the multi-thread auction system(s) 142 can perform actions for each bid, based on their ordering in the bid queue.

FIG. 5B illustrates an example network schematic 540 for the multi-platform sequencer engine 230, according to some embodiments. As illustrated, the multi-platform sequencer engine 230 comprises an active model data generator 545, a machine learning engine 550, and a multi-thread communication queue 555, according to some example embodiments. Initially, the active model data generator 545 generates active data to generate a model by sending ping packets to different platforms, such as a first social network server 570 and a second social network server 571. The ping packets may be returned from the respective servers, and the active model data generator 545 may store the ping packet data as model data. In this way, the active model data generator 545 actively probes different network layouts to generate a training model, and is thus adaptable for a variety of different messaging platforms, or social networks.

The machine learning engine 550 may receive a plurality of network communications, including a first bid 551, which was submitted by a first user through the first social network server 570, and a second bid 552, which was submitted by a second user through the second social network server 571. In the example illustrated, assume that the first bid 551 was received by the machine learning engine 550 three seconds before the second bid 552 was received by the machine learning engine 550. As discussed above, the machine learning engine 550 is trained on model data generated by the active model data generator 545. In training, assume that the machine learning engine 550 uses random forest to generate strong signals from a collection of weak signals. A first strong signal may determine that the delay time for packets from the first social network server 570 is 500 milliseconds, while a second strong signal may determine that the delay time for packets from the second social network server 571 is five seconds. Using the trained model, the machine learning engine 550 intelligently determines that the second bid 552 was actually submitted before the first bid 551, but still arrived after the first bid 551 due to the large network delay of the second social network server 571. Accordingly, the machine learning engine 550 puts the bids in the multi-thread communication queue 555 in an order indicating that the second bid 552 should be handled (e.g., submitted) before the first bid 551. Though bids are used here as example communications, in some example embodiments, all communications received by the multi-platform sequencer engine 230 are handled in a similar manner: adjusting for delay times, and placing in the multi-thread communication queue 555 based on the receive times offset by the delay times. Once the communications are in the multi-thread communication queue 555, the action engine 240 may handle the communications in the multi-thread communication queue 555 according to which is next up in the multi-thread communication queue 555. For example, as the second bid 552 is placed before the first bid 551 in the multi-thread communication queue 555, the action engine 240 accordingly submits the second bid 552 to the auction instance before submitting the first bid 551 to the auction instance.

Though the example illustrated in FIG. 5B uses only two bids and two platforms, it is to be appreciated that in real network implementations the number of communications to be handled may be in the thousands, and further, the number of platforms submitting the communications may be greater than two. For example, the multi-thread auction system 142 may manage an auction for an item, with bids being received from all over the world, from several different platforms, e.g., Facebook, Twitter, gchat, WhatsApp, etc. The multi-platform sequencer engine 230 assures fairness in any complex network scenario by assuring that communications are handled according to the time they were submitted by the user, and not the time they are received by the multi-thread auction system(s) 142.

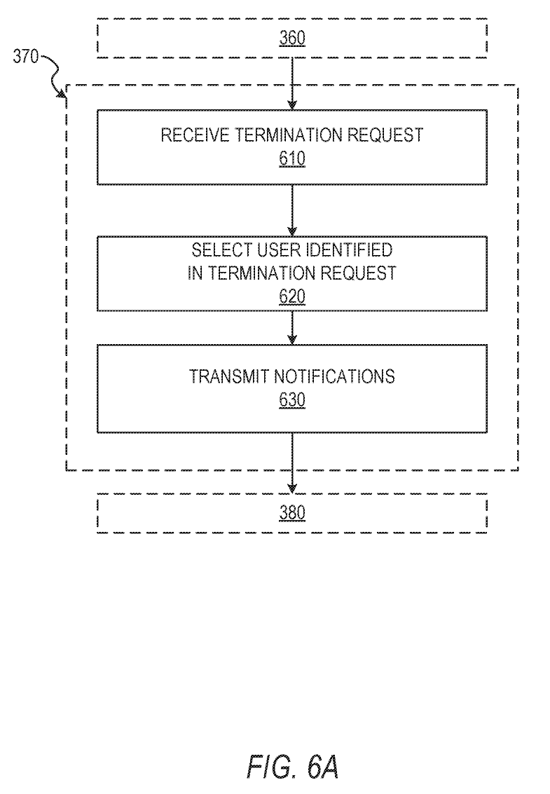

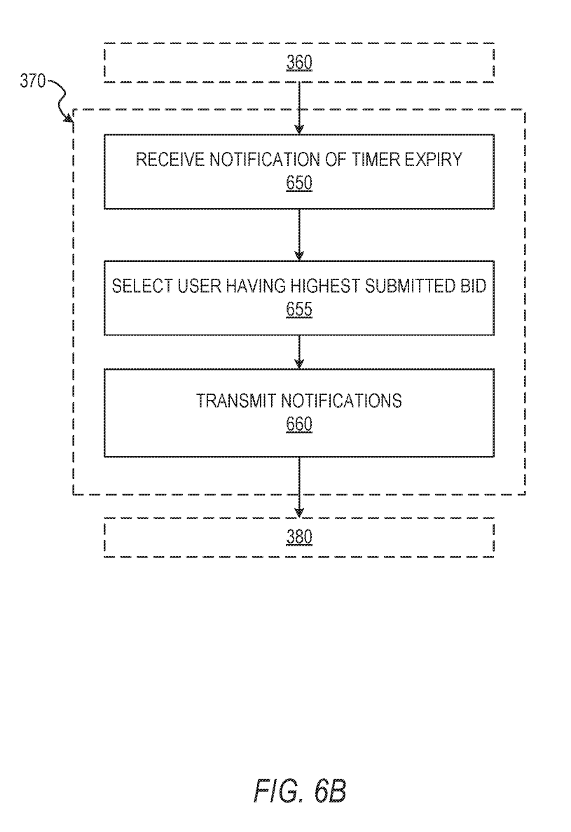

FIGS. 6A and 6B show example subroutines for operation 370 of FIG. 3, which is a termination event-related operation. In FIG. 6A, at operation 610, the action engine 240 receives a termination message. For example, the action engine 240 may receive a termination message from the seller of the item, the message specifying which bidder wins the item, and a termination The action engine 240 is configured to identify the termination tag and terminate the auction instance based on identifying the termination tag. At operation 620, the auction engine 250 selects the user identified in the termination as the winner of the auction for the item. At operation 630, the action engine 240 generates a number of notifications to be sent to bidders through one or more messaging platforms. The notification messages notify the bidders that the auction is closed, and can further notify losing bidders that they did not win the item, notify the winning bidder that they won the auction for the item, and link the winning bidder to a checkout instance, as generated by the clearance engine 270.

FIG. 6B illustrates a termination process involving an expiry of a timer, according to some example embodiments. At operation 650, the action engine 240 receives notification of the termination event as a notification of a timer expiration. For example, the auction may be set to expire or end in 24 hours. In some embodiments, the auction engine 250 tracks and manages a timer, and updates the timer event upon expiration. At operation 655, the auction engine 250 selects the user who has the highest submitted bid as of the time the tinier expires. The user with the highest bid is selected the winner of the auction for the item. The auction engine 250 may transfer the identification of the winning bidder to the clearance engine 270. The clearance engine 270 may generate a checkout instance to check out the item and pay for it, and create a link to the checkout instance. At operation 660, notifications are transmitted to the users of the auction on different messaging APIs using the messaging API engine 210. The messages transmitted at operation 660 may differ, depending on which user the message is being sent to. For example, a user who lost the auction will receive a message letting the user know that the auction is over and that they did not win. A user who won the auction may receive a message that indicates that they won the auction, and that further includes a link to the checkout instance, as generated by the clearance engine 270.

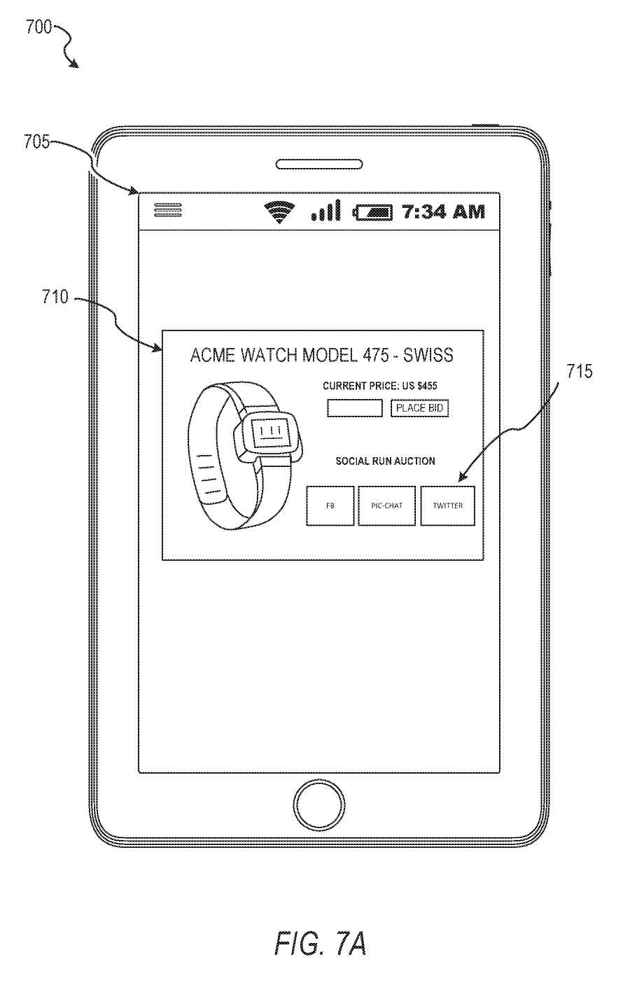

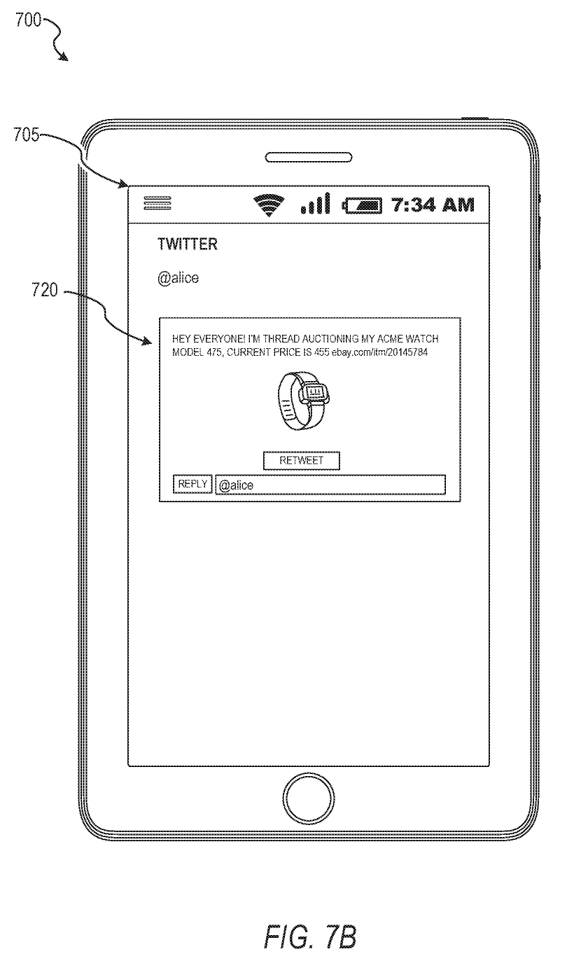

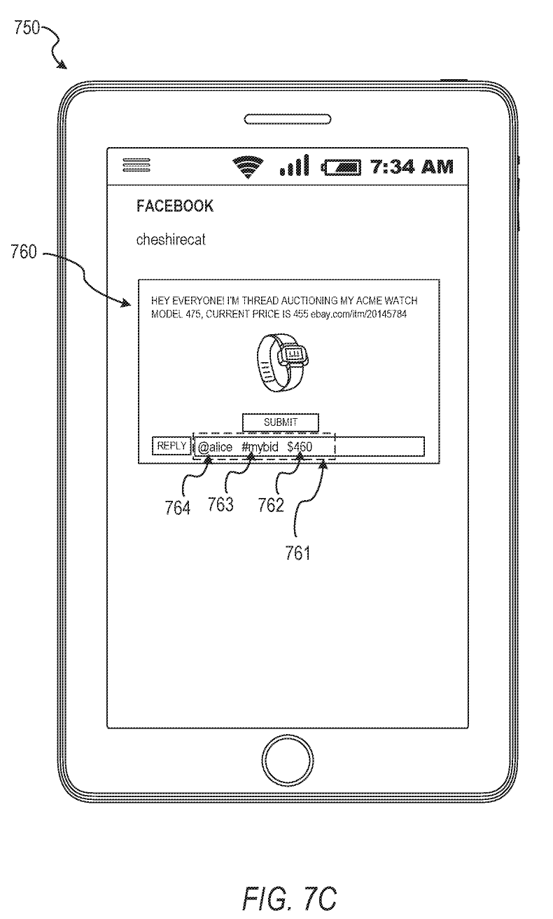

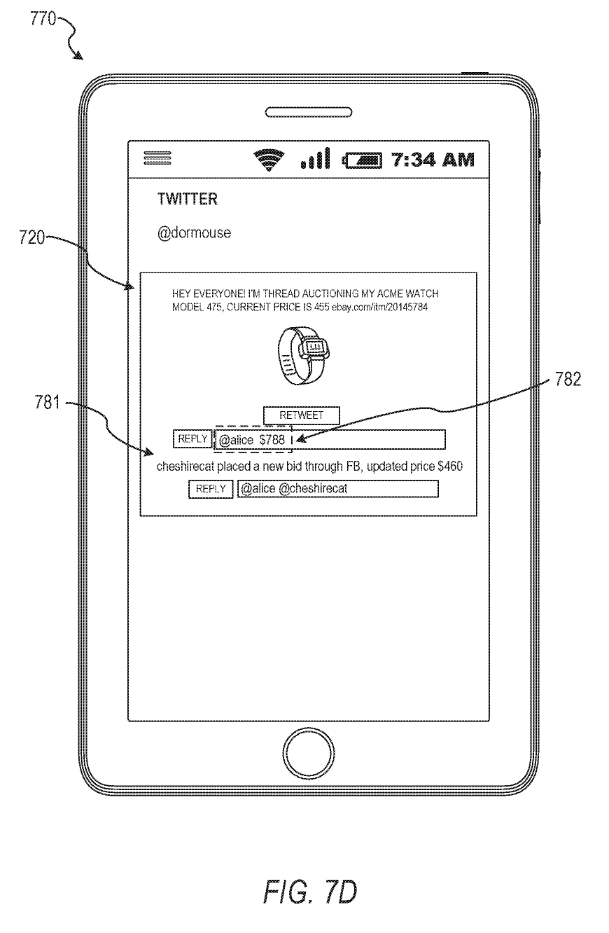

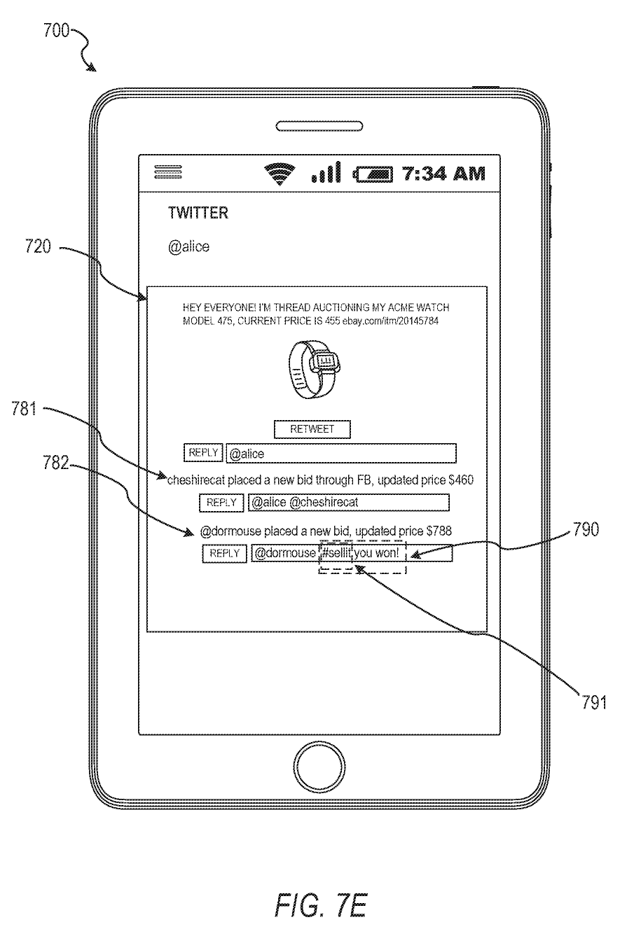

FIG. 7A illustrates a client device 700 for the seller “Alice”, according to some example embodiments. The client device 700 has a user interface 705, which is displaying an auction page 710 (e.g., webpage) for an item being auctioned, which is an Acme Watch Model 475. As illustrated, the auction page 710 may comprise multi-thread auction initiation buttons 715 for different social networks, such as Facebook, Pic-Chat, and Twitter. Upon selection of one of the buttons by the seller, the auction engine 250 can generate a message thread for the selected social network or platform, as discussed with reference to FIGS. 7B-E. Though the example illustrated in FIGS. 7A-E shows a multi-thread auction being initiated from an already created auction instance, it is to be appreciated that in some embodiments, the auction instance and corresponding auction page 710 may be generated by posting about the item on a message thread that interfaces with the multi-thread auction system(s) 142 to generate an auction instance, as discussed above.

FIG. 7B illustrates a message thread 720 generated in response to clicking on one of the multi-thread auction initiation buttons 715. For example, if the Twitter multi-thread auction button is selected, the message thread 720 is implemented as a “tweet”, which can display the item being auctioned, a link to the auction page, and reply comment fields. In some embodiments, multiple message threads for different platforms are generated and posted to the different platforms so that friends of the seller can bid on the item through any of the platforms.

FIG. 7C illustrates a second client device 750 of a first bidding user “cheshirecat”, according to some example embodiments. The second client device 750 displays a message thread 760 posted by the multi-thread auction system(s) 142 on a second platform “Facebook” for the item being auctioned, the Acme Watch Model 475. The message thread 760 may be implemented as a post to a timeline, wall, and the like, within Facebook. The first bidding user “cheshirechat” can generate a bid request 761, comprising a bid tag 763 a seller tag 764, and an initial price value 762. In some embodiments, the item being bid on, the bidder, and the seller are all tracked through metadata not necessarily displayed in the bid request 761. For example, while in some embodiments the bid request 761 may require that the seller tag 764 be included in the bid request 761, in some embodiments the action engine 240 generates the message thread 760 with special header identifiers. When the bidder submits a price through reply, the header identifiers identify to the action engine 240 the account of the person who posted the message thread 760 (e.g., the seller “Alice”), as well as the account of the bidder (e.g., the first bidder “cheshirecat”). In this way, the complexity of the bid request messages can be reduced.

When the first bidding user “cheshirecat” submits the bid request 761, the messaging API engine 210 receives the request, and the action engine 240 identifies the request as a bid request by the bid tag 763 (or through header identifiers) and updates the auction instance to reflect the current bid price of $460, from the first bidder “cheshirecat”. The time at which the “Reply” button is selected is the time which the multi-platform sequencer engine 230 is seeking to determine by deducting the machine-learned delay time from the time of bid request receipt.

FIG. 7D shows a third client device 770 for a second bidding user “dormouse”, who is viewing the message thread 720 on the original platform, Twitter, according to some example embodiments. The message thread 720 displays the original information posted by the seller “Alice”, as well as an additional comment 781, which notifies users of a bid price update. As displayed, the additional comment 781 notifies users that the updated bid price of $460 was submitted by “cheshirecat” through Facebook (“FB”), e.g., through a different thread on a different platform.

The second bidding user “dormouse” may submit a bid request 782 increasing the bid to $788. As displayed, according to some example embodiments, the bid request 782 does not use a bid tag (e.g., “#mybid”); however, the action engine 240 may still identify the second bidding user “dormouse” as a bidder based on the bid request 782 including a price increase and based on the fact that the bid request 782 is a reply on an auction thread for the item.

FIG. 7E shows the client device 700 of the seller “Alice”. The message thread 720 displays the additional comment 781 of the first bid made by “cheshirecat” through Facebook, as well as the bid request 782, which states that the second bidding user “dormouse” increased the bid to $788. The seller “Alice” can end the auction by submitting a termination message 790 which includes a termination tag 791 and a text message notifying “dormouse” that he won. Upon “Alice” submitting the termination message 790, the auction engine 250 may end the auction and generate notification messages to be sent to the bidders. For example, a first termination message may be posted on the message thread 760 (on Facebook) notifying “cheshirecat” that he did not win, and a second termination message may be posted on the message thread 720 notifying “dormouse” that he won and linking “dormouse” to a checkout instance generated by the clearance engine 270 to clear the payments and finish the auction transaction.

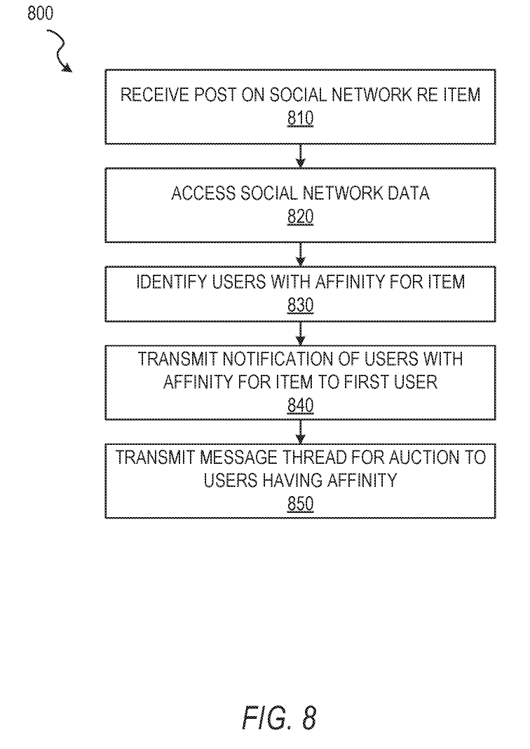

FIG. 8 is a flow diagram 800 illustrating a method of connecting potential buyers to a seller through connections of the seller, according to some embodiments. At operation 810, the messaging API engine 210 receives an indication that a post about an item for sale has been posted to the social network platform 131. At operation 820, the social graph API engine 220 accesses social graph data of the social network platform 131. At operation 830, the connection engine 260 identifies users who are connected to the seller (e.g., “friends”) and who have an affinity for the item posted about in the post. An affinity may be determined from the user profile data of the users. For example, the user profile datasets of the various friends of the seller may be analyzed to find keywords associated with the item. At operation 840, the messaging API engine 210 transmits a notification of users (e.g., friends) who have an affinity for the item to the seller. For example, once the multi-thread auction system 142 determines that a friend of the seller has an affinity for the item being posted about, a message will be sent to the seller saying, “Your friend, Bob Smith, may be interested in buying the item. Do you want to message him?” Assuming that the seller selects “yes”, at operation 850 a message thread, such as the message thread 720 or the message thread 760, can be posted to the walls or profiles of the friends identified as having an affinity for the item. Once the message threads are posted to the walls of the friends having an affinity, the multi-thread auction system(s) 142 may manage the auction through the multiple platforms as explained above.

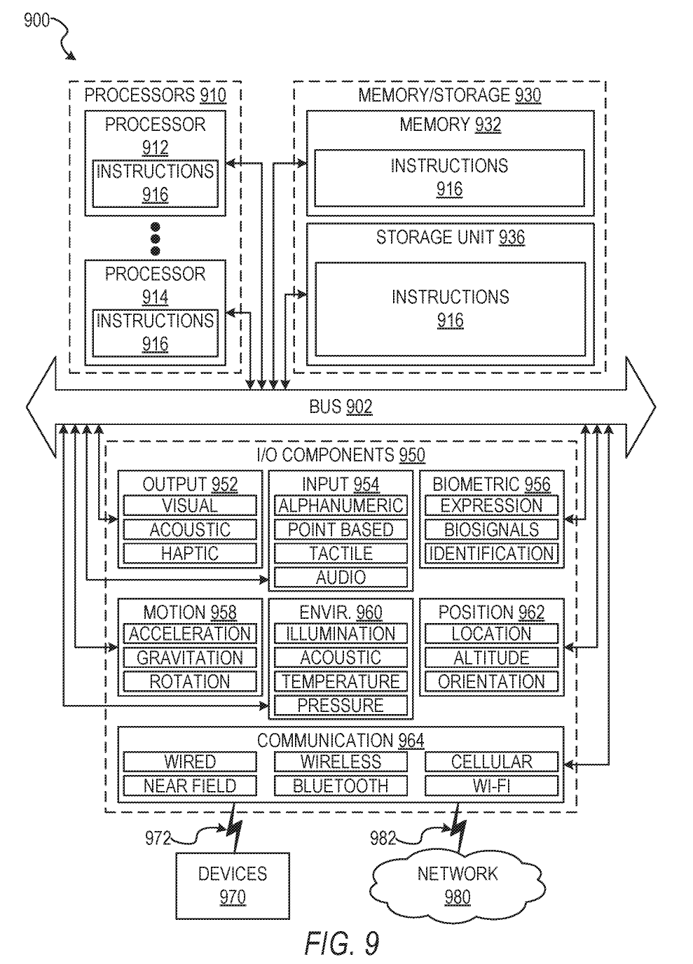

FIG. 9 is a block diagram illustrating components of a machine 900, according to some example embodiments, able to read instructions from a machine-readable medium (e.g., a machine-readable storage medium) and perform any one or more of the methodologies discussed herein. Specifically, FIG. 9 shows a diagrammatic representation of the machine 900 in the example form of a computer system, within which instructions 916 (e.g., software, a program, an application, an applet, an app, or other executable code) for causing the machine 900 to perform any one or more of the methodologies discussed herein can be executed. For example, the instructions 916 can cause the machine 900 to execute the flow diagrams of FIGS. 3, 4,, 5A, 6A, 6B, and 8. Additionally, or alternatively, the instructions 916 can implement the messaging API engine 210, the social graph API engine 220, the multi-platform sequencer engine 230, the action engine 240, the auction engine 250, the connection engine 260, and the clearance engine 270 of FIG. 2, and so forth. The instructions 916 transform the general, non-programmed machine into a particular machine programmed to carry out the described and illustrated functions in the manner described. In alternative embodiments, the machine 900 operates as a standalone device or can be coupled (e.g., networked) to other machines. In a networked deployment, the machine 900 may operate in the capacity of a server machine or a client machine in a server--client network environment, or as a peer machine in a peer-to-peer (or distributed) network environment. The machine 900 can comprise, but not be limited to, a server computer, a client computer, a personal computer (PC), a tablet computer, a laptop computer, a netbook, a set-top box (STB), a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 916, sequentially or otherwise, that specify actions to be taken by the machine 900. Further, while only a single machine 900 is illustrated, the term “machine” shall also be taken to include a collection of machines 900 that individually or jointly execute the instructions 916 to perform any one or more of the methodologies discussed herein.

The machine 900 can include processors 910, memory/storage 930, and I/O components 950, which can be configured to communicate with each other such as via a bus 902. In an example embodiment, the processors 910 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an Application Specific Integrated Circuit (ASK:), a Radio-Frequency Integrated Circuit (RFIC), another processor, or any suitable combination thereof) can include, for example, a processor 912 and a processor 914 that may execute the instructions 916. The term “processor” is intended to include a multi-core processor that may comprise two or more independent processors (sometimes referred to as “cores”) that can execute instructions contemporaneously. Although FIG. 9 shows multiple processors 910, the machine 900 may include a single processor with a single core, a single processor with multiple cores (e.g., a multi-core processor), multiple processors with a single core, multiple processors with multiples cores, or any combination thereof.

The memory/storage 930 can include a memory 932, such as a main memory, or other memory storage, and a storage unit 936, both accessible to the processors 910 such as via the bus 902. The storage unit 936 and memory 932 store the instructions 916 embodying any one or more of the methodologies or functions described herein. The instructions 916 can also reside, completely or partially, within the memory 932, within the storage unit 936, within at least one of the processors 910 (e.g., within the processor's cache memory), or any suitable combination thereof, during execution thereof by the machine 900. Accordingly, the memory 932, the storage unit 936, and the memory of the processors 910 are examples of machine-readable media.

As used herein, the term “machine-readable medium means a device able to store instructions and data temporarily or permanently and may include, but not be limited to, random-access memory (RAM), read-only memory (ROM), buffer memory, flash memory, optical media, magnetic media, cache memory, other types of storage (e.g., Erasable Programmable Read-Only Memory (EEPROM)), or any suitable combination thereof. The term machine-readable medium” should be taken to include a single medium or multiple media (e.g., a centralized or distributed database, or associated caches and servers) able to store the instructions 916. The term “machine-readable medium” shall also be taken to include any medium, or combination of multiple media, that is capable of storing instructions (e.g., instructions 916) for execution by a machine (e.g., machine 900), such that the instructions, when executed by one or more processors of the machine (e.g., processors 910), cause the machine to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” excludes signals per se.

The I/O components 950 can include a wide variety of components to receive input, provide output, produce output, transmit information, exchange information, capture measurements, and so on. The specific I/O components 950 that are included in a particular machine will depend on the type of machine. For example, portable machines such as mobile phones will likely include a touch input device or other such input mechanisms, while a headless server machine will likely not include such a touch input device. It will be appreciated that the I/O components 950 can include many other components that are not shown in FIG. 9. The I/O components 950 are grouped according to functionality merely for simplifying the following discussion, and the grouping is in no way limiting. In various example embodiments, the I/O components 950 can include output components 952 and input components 954. The output components 952 can include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 954 can include alphanumeric input components (e.g., a keyboard, a touch screen configured to receive alphanumeric input, a photo-optical keyboard, or other alphanumeric input components), point based input components (e.g., a mouse, a touchpad, a trackball, a joystick, a motion sensor, or other pointing instruments), tactile input components (e.g., a physical button, a touch screen that provides location and force of touches or touch gestures, or other tactile input components), audio input components (e.g., a microphone), and the like.

In further example embodiments, the I/O components 950 can include biometric components 956, motion components 958, environmental components 960, or position components 962 among a wide array of other components. For example, the biometric components 956 can include components to detect expressions (e.g., hand expressions, facial expressions, vocal expressions, body gestures, or eye tracking), measure biosignals (e.g., blood pressure, heart rate, body, temperature, perspiration, or brain waves), identify a person (e.g., voice identification, retinal identification, facial identification, fingerprint identification, or electroencephalogram based identification), and the like. The motion components 958 can include acceleration sensor components (e.g., an accelerometer), gravitation sensor components, rotation sensor components (e.g., a gyroscope), and so forth. The environmental components 960 can include, for example, illumination sensor components (e.g., a photometer), temperature sensor components (e.g., one or more thermometers that detect ambient temperature), humidity sensor components, pressure sensor components (e.g., a barometer), acoustic sensor components (e.g., one or more microphones that detect background noise), proximity sensor components (e.g., infrared sensors that detect nearby objects), gas sensor components (e.g., machine olfaction detection sensors, gas detection sensors to detect concentrations of hazardous gases for safety or to measure pollutants in the atmosphere), or other components that may provide indications, measurements, or signals corresponding to a surrounding physical environment. The position components 962 can include location sensor components (e.g., a Global Positioning System (GPS) receiver component), altitude sensor components (e.g., altimeters or barometers that detect air pressure from which altitude may be derived), orientation sensor components (e.g., magnetometers), and the like.

Communication can be implemented using a wide variety of technologies. The I/O components 950 may include communication components 964 operable to couple the machine 900 to a network 980 or devices 970 via a coupling 982 and a coupling 972, respectively. For example, the communication components 964 include a network interface component or other suitable device to interface with the network 980. In further examples, the communication components 964 include wired communication components, wireless communication components, cellular communication components, Near Field Communication (NFC) components, BLUETOOTH® components (e.g., BLUETOOTH® Low Energy), WI-FI® components, and other communication components to provide communication via, other modalities. The devices 970 may be another machine or any of a wide variety of peripheral devices (e.g., a peripheral device coupled via a Universal Serial Bus (USB)).

Moreover, the communication components 964 can detect identifiers or include components operable to detect identifiers. For example, the communication components 964 can include Radio Frequency Identification (RBI)) tag reader components, NFC smart tag detection components, optical reader components (e.g., an optical sensor to detect one-dimensional bar codes such as a Universal Product Code (UPC) bar code, multi-dimensional bar codes such as a Quick Response (QR) code. Aztec Code, Data Matrix, Dataglyph, MaxiCode, PDF417, Ultra Code, Uniform Commercial Code Reduced Space Symbology (UCC RSS)-2D bar codes, and other optical codes), acoustic detection components (e.g., microphones to identify tagged audio signals), or any suitable combination thereof. In addition, a variety of information can be derived via the communication components 964, such as location via Internet Protocol (IP) geo-location, location via WI-FI® signal triangulation, location via detecting a BLUETOOTH® or NFC beacon signal that may indicate a particular location, and so forth.

In various example embodiments, one or more portions of the network 980 can be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a WI-FI® network, another type of network, or a combination of two or more such networks. For example, the network 980 or a portion of the network 980 may include a wireless or cellular network, and the coupling 982 may be a Code Division Multiple Access (CDMA) connection, a Global System for Mobile communications (GSM) connection, or another type of cellular or wireless coupling. In this example, the coupling 982 can implement any of a variety of types of data transfer technology, such as Single Carrier Radio Transmission Technology (1xRTT), Evolution-Data Optimized (EVDO) technology, General Packet Radio Service (CPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard-setting organizations, other long range protocols, or other data transfer technology.

The instructions 916 can be transmitted or received over the network 980 using a transmission medium via a network interface device (e.g., a network interface component included in the communication components 964) and utilizing any one of a number of well-known transfer protocols (e.g., Hypertext Transfer Protocol (HTTP)). Similarly, the instructions 916 can be transmitted or received using a transmission medium via the coupling 972 (e.g., a peer-to-peer coupling) to the devices 970. The term “transmission medium” shall be taken to include any intangible medium that is capable of storing, encoding, or carrying the instructions 916 for execution by the machine 900, and includes digital or analog communications signals or other intangible media to facilitate communication of such software.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Although an overview of the inventive subject matter has been described with reference to specific example embodiments, various modifications and changes may be made to these embodiments without departing from the broader scope of embodiments of the present disclosure, Such embodiments of the inventive subject matter may be referred to herein, individually or collectively, by the term “invention” merely for convenience and without intending to voluntarily limit the scope of this application to any single disclosure or inventive concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

What is claimed is:

1. A method comprising:
receiving, from a first user through an application programming interface (API) of a messaging webservice, an auction request to initiate an auction on the messaging webservice for an item, the auction request comprising a sell metadata tag and initial price data for the item, the auction request corresponding to a message thread on the messaging webservice;
responsive to the auction request, generating, by an auction server, an auction instance for the item;
receiving, from a second user through the API of the messaging webservice, a bid request for the auction, the bid request originating from the message thread, the bid request comprising a bid metadata tag and bid price data;
receiving, from a third user through the API of the messaging webservice, an additional bid request for the auction, the additional bid request originating from the message thread, the additional bid request comprising the bid metadata tag and additional bid price data;
receiving, from the first user through the API of the messaging webservice, an electronic message comprising a termination metadata tag and an identifier of the third user, the electronic message originating from the message thread; and
responsive to the receiving the electronic message, terminating, by the auction server, the auction instance for the item and transmitting through the API of the messaging webservice an auction termination message.

2. The method of claim 1, wherein transmitting through the API of the messaging webservice the auction termination message comprises:
transmitting, to the second user, a first termination notification message; and
transmitting, to the third user, a second termination notification message comprising a link to a checkout instance for the item, the checkout instance provided by the auction server.

3. The method of claim 2, wherein the first termination notification message and the second termination notification message are posted on the message thread through the API of the messaging webservice

4. The method of claim 1, further comprising:
responsive to receiving the additional bid request from the third user, transmitting, to the second user through the API of the messaging webservice, notification comprising the additional bid price data.

5. The method of claim 1, further comprising:
determining respective times that each of the bid request and the additional bid request were initiated, the determining comprising using a machine learning scheme to analyze bid request metadata of the bid request and the additional bid request to generate initiation times for each of the bid request and the additional bid request,
wherein the machine learning scheme is trained on historical bid request metadata associated with the messaging webservice, the historical bid request metadata including at least one or more of a group comprising:
a number of network hubs that packets associated with historical bid requests traversed,
a country of origin of the historical bid requests,
sizes of the packets of the historical bid requests, and
a messaging webservice type, wherein messaging webservices of different types are accessible through different APIs.

6. The method of claim 5, further comprising:
determining that the additional bid request was initiated after the bid request, the determining comprising determining that the bid request was initiated at a first initiation time and that the additional bid request was initiated at a second initiation time later than the first initiation time; and
responsive to determining that the additional bid request was initiated after the bid request, submitting, by the auction server, the bid request to the auction instance and then submitting, by the auction server, the additional bid request to the auction instance.

7. The method of claim 1, wherein the messaging webservice is a webservice of a social network platform, the method further comprising:
identifying a post on the social network platform submitted by the first user, the post referencing the item, the identifying of the post occurring before receiving the auction request;
accessing, through a social graph API of the social network platform, social graph data for members of the social network platform, the members comprising the first user, the second user, and the third user;
identifying the second user as a connection to the first user using the social graph data; and.
based at least in part on the identifying the second user as a connection to the first user, transmitting, to the first user through the API of the messaging webservice, a notification of the second user as a connection.

8. The method of claim 7, wherein transmitting the notification is further based at least in part on determining that the second user submitted a separate post on the social network platform referencing the item.

9. The method of claim 7, wherein transmitting the notification is further based at least in part on determining that the second user has an affinity for the item based on keywords associated with the item existing in user profile data of the second user.

10. A system comprising:
one or more processors of a machine; and
a memory storing instructions that, when executed by the the one or more processors, cause the machine to at least:
receive, from a first user through an application programming interface (API) of a messaging webservice, an auction request to initiate an auction on the messaging webservice for an item, the auction request comprising a sell metadata tag and initial price data for the item, the auction request corresponding to a message thread on the messaging webservice;
responsive to the auction request, generate, by an auction server, an auction instance for the item;
receive, from a second user through the API of the messaging webservice, a bid request for the auction, the bid request originating from the message thread, the bid request comprising a bid metadata tag and bid price data;
receive, from a third user through the API of the messaging webservice, an additional bid request for the auction, the additional bid request originating from the message thread, the additional bid request comprising the bid metadata tag and additional bid price data;
receive, from the first user through the API of the messaging webservice, an electronic message comprising a termination metadata tag and an identifier of the third user, the electronic message originating from the message thread; and
responsive to the receiving the electronic message, terminate, by the auction server, the auction instance for the item and transmit through the API of the messaging webservice an auction termination message.

11. The system of claim 10, wherein transmitting through the API of the messaging webservice the auction termination message comprises:
transmitting, to the second user, a first termination notification message; and
transmitting, to the third user, a second termination notification message comprising a link to a checkout instance for the item, the checkout instance provided by the auction server.

12. The system of claim 11, wherein the first termination notification message and the second termination notification message are posted on the message thread through the API of the messaging webservice.

13. The system of claim 10, wherein the instructions further cause the machine to:
responsive to receiving the additional bid request from the third user, transmit, to the second user through the API of the messaging webservice, a notification comprising the additional bid price data.

14. The system of claim 10, wherein the instructions further cause the machine to:
determine respective times that each of the bid request and the additional bid request were initiated, the determining comprising use a machine learning scheme to analyze bid request metadata of the bid request and the additional bid request to generate initiation times for each of the bid request and the additional bid request,
wherein the machine learn scheme is trained on historical bid request metadata associated with the messaging webservice, the historical bid request metadata including at least one or more of a group comprising:
a number of network hubs that packets associated with historical bid requests traversed,
a country of origin of the historical bid requests,
sizes of the packets of the historical bid requests, and
a messaging webservice type.

15. The system of claim 14, wherein the instructions further cause the machine to:
determine that the additional bid request was initiated after the bid request, the determining comprising determining that the bid request was initiated at a first initiation time and that the additional bid request was initiated at a second initiation time later than the first initiation time; and
responsive to determining that the additional bid request was initiated after the bid request, submit, by the auction server, the bid request to the auction instance and then submit, by the auction server, the additional bid request to the auction instance.

16. The system of claim 10, wherein the messaging webservice is a webservice of a social network platform, and wherein the instructions further cause the machine to:
identify a post on the social network platform submitted by the first user, the post referencing the item, the identifying of the post occurring before receiving the auction request;
access, through a social graph API of the social network platform, social graph data for members of the social network platform, the members comprising the first user, the second user, and the third user;
identify the second user as a connection to the first user using the social graph data; and
based at least in part on the identifying the second user as a connection to the first user, transmit, to the first user through the API of the messaging webservice, a notification of the second user as a connection.

17. The, system of claim 16, wherein transmitting the notification is further based at least in part on determining that the second user submitted a separate post on the social network platform referencing the item.

18. The system of claim 16, wherein transmitting the notification is further based at least in part on determining that the second user has an affinity for the item based on keywords associated with the item existing in user profile data of the second user.

19. A non-transitory machine-readable storage medium embodying instructions that, when executed by a machine, cause the machine to perform operations comprising:
receiving, from a first user through an application programming interface (API) of a messaging webservice, an auction request to initiate an auction on the messaging webservice for an item, the auction request comprising a sell metadata tag and initial price data for the item, the auction request corresponding to a message thread on the messaging webservice;
responsive to the auction request, generating, by an auction server, an auction instance for the item;
receiving, from a second user through the API of the messaging webservice, a bid request for the auction, the bid request originating from the message thread, the bid request comprising a bid metadata tag and bid price data;
receiving, from a third user through the API of the messaging webservice, an additional bid request for the auction, the additional bid request originating from the message thread, the additional bid request comprising the bid metadata tag and additional bid price data;
receiving, from the first user through the API of the messaging webservice, an electronic message comprising a termination metadata tag and an identifier of the third user, the electronic message originating from the message thread; and
responsive to the receiving the electronic message, terminating, by the auction server, the auction instance for the item and transmitting through the API of the messaging webservice an auction termination message.

20. The machine-readable storage medium of claim 19, wherein transmitting through the API of the messaging webservice the auction termination message comprises:
transmitting, to the second user, a first termination notification message; and
transmitting, to the third user, a second termination notification message comprising a link to a checkout instance for the item, the checkout instance provided by the auction server; and wherein
the first termination notification message and the second termination notification message are posted on the message thread through the API of the messaging webservice.
